(19) United States
(12) Patent Application Publication
(10) Pub. No.: US 2011/0069025 A1
(43) Pub. Date: Mar. 24, 2011

(54) MIXING CONSOLE

(75) Inventors: Hiroaki FUJITA, Hamamatsu-shi (JP); Kotaro TERADA, Hamamatsu-shi (JP)

(73) Assignee: YAMAHA CORPORATION, Hamamatsu-shi (JP)

(21) Appl. No.: 12/876,609

(22) Filed: Sep. 7, 2010

(30) Foreign Application Priority Data
Sep. 18, 2009 (JP) 2009-216605

(51) Int. Cl. G06F 3/041

(52) U.S. Cl. 345/173

(57) ABSTRACT

Once a parameter is focused and defined as a target parameter on a main display, a utility area S-2 provided on a sub-display 14c displays a numeric keypad 56 which is a screen for inputting a value of the target parameter. The numeric keypad 56 varies depending on the type of a target parameter. When a user touches the numeric keypad 56 to input a value, the target parameter is updated with the input value.

### BACKGROUND OF THE INVENTION

1. Field of the Invention

The present invention relates to a mixing console having a sub-display which displays, at all times, an ancillary menu relating to a target parameter displayed on a main display.

2. Description of the Related Art

Conventionally, there have been mixing consoles for use in a concert hall or the like, the conventional mixing consoles controlling respective levels and frequency responses of audio signals output from a multiplicity of microphones and electric/electronic musical instruments placed on a stage or the like, mixing the controlled signals, and then transmitting the mixed signals to a power amplifier. By use of various kinds of panel operating elements provided on the conventional mixing console, a user of the mixing console controls respective tone volumes and tone colors of audio signals representative of tones of musical instruments and vocals to realize a state in which performances are most suitably represented. The mixing console has buses for mixing sound signals input from input channels, and output channels for outputting the mixed sound signals. The respective input channels control frequency response and mixing level of sound signals input to the input channels, and then output the controlled sound signals to the mixing buses. The mixing buses mix the input sound signals, and then output the mixed signals to their respective output channels. Respective outputs from the output channels are amplified to be emitted by speakers and the like.

On the conventional mixing consoles, parameter values for use in signal processing can be edited by user's manipulation. For example, there is a known mixing console which displays on a main display unit, a GUI (graphical user interface) screen for accepting the editing of parameters. On this conventional mixing console, in addition, the main display unit has a touch panel so that a user can touch the screen directly to manipulate the GUI. The conventional mixing console is designed such that by user's manipulation of a button or field corresponding to a certain parameter on a main screen displayed on the main display unit, a pop-up window displaying details or a list of the parameter appears to allow the user to edit the parameter in detail on the pop-up window. This is because the main screen is not large enough to display the GUI necessary to accept user's manipulations of detailed editing of a parameter. If the GUI were displayed on the main screen, the main screen would have to display in small letters, reducing visibility and operability.

In a case where the pop-up window is displayed on the main display unit, the main screen placed beneath the pop-up window is invisible during the display of the pop-up window. If the display scheme is simply modified such that the pop-up window is displayed apart from the main screen, the modified scheme requires the user to select a target parameter to edit on the main screen before moving to the pop-up window situated away from the main screen to edit the target parameter, reducing operability due to the manipulations at separate locations. In order to solve the above-described problem, therefore, there has been a conventional mixing console (e.g., Japanese Unexamined Patent Publication No. 2007-267135). The disclosed mixing console is provided with a touch panel which displays a detailed editing screen separately from a display panel which displays a main screen so that by a double click on an operating element or a block relating to a parameter on the main screen, the detailed editing screen corresponding to the clicked operating element or block will be displayed on the touch panel. On the detailed editing screen displayed on the touch panel, buttons and the like for editing a plurality of parameters are displayed so that a user of the disclosed mixing console can edit the respective parameters by manipulating the buttons and the like.

### SUMMARY OF THE INVENTION

However, the disclosed mixing console is designed to display the detailed editing screen on the touch panel in order to edit a plurality of parameters on the touch panel only when the specific manipulation (double click) is performed on the main screen. That is, the detailed editing screen is not displayed at all times. Furthermore, the detailed editing screen only displays the parameters. Therefore, the touch panel is not able to display ancillary operating functions such as copy and paste of a selected parameter, failing to allow the user to perform the ancillary operating functions by use of the touch panel. In addition, the disclosed mixing console is not designed to display on the touch panel, a screen tailored to the type of a parameter selected as a target parameter, failing to offer simple parameter editing.

The present invention was accomplished to solve the above-described problem, and an object thereof is to provide a mixing console which displays, on a sub-display, a screen tailored to the type of a parameter selected on a display screen of a main display as a target parameter.

In order to achieve the above-described object, it is the primary feature of the present invention to provide a mixing console including a first display portion which has a touch panel capability and displays sets of parameters, the sets relating to respective channels; a selector which determines a parameter which is a target parameter to control, by detecting a touch of the first display portion to select the parameter corresponding to the touch from among the plurality of parameters displayed on the first display portion, and detecting a manipulation of an operating element for selecting a channel to select a channel corresponding to the manipulated operating element from among the channels; a second display portion which has a touch panel capability and displays at all times a screen on which, in a case where the target parameter has been determined by the selector, a value relating to the parameter is input, and whose manner of inputting the value varies according to the type of the target parameter determined by the selector; a first editor which allows editing of the parameters displayed on the first display portion, independently of what is displayed on the second display portion; and a second editor which updates, in a case where the value relating to the target parameter has been input on the screen displayed on the second display portion, the parameter defined as the target parameter with the input value.

According to the present invention, the second display portion displays a screen on which, in a case where the target parameter has been determined, a value relating to the parameter is input, and whose manner of inputting the value varies according to the type of the target parameter. Consequently, the mixing console according to the present invention is able to display a screen tailored to the inputting of a value of the target parameter at all times on the second display portion. Thus, the mixing console of the present invention facilitates user's input of a numeric value and user's control of surround pan, also allowing at all times a user to control the parameters displayed on the first display portion independently of what is displayed on the second display portion.

### BRIEF DESCRIPTION OF THE DRAWINGS

FIG. 1 is a block diagram indicative of a configuration of a mixing console according to an embodiment of the present invention;

FIG. 2 is a block diagram indicative of an equivalent hardware configuration of a mixing algorithm executed on the mixing console of the present invention;

FIG. 3 is a configuration of a display portion of the mixing console of the present invention and a configuration of operating elements placed on a panel;

FIG. 4 is an example screen displayed on a main display of the mixing console of the present invention;

FIG. 5 is the other example screen displayed on the main display of the mixing console of the present invention;

FIG. 6 is an example screen of a sub-display which displays a context menu on a utility area of the sub-display of the mixing console of the present invention;

FIG. 7 is the other example screen of the sub-display which displays a context menu on the utility area of the sub-display of the mixing console of the present invention;

FIG. 8 is a screen switched from the screen indicated in FIG. 7;

FIG. 9 is an example display manner of a context pad displayed on the utility area of the sub-display of the mixing console of the present invention;

FIG. 10 is the other example display manner of the context pad displayed on the utility area of the sub-display of the mixing console of the present invention;

FIG. 11 is a flowchart of a target parameter determination process carried out on the mixing console of the present invention;

FIG. 12 is a flowchart of a context menu/pad drawing process executed on the mixing console of the present invention; and

FIG. 13 is a memory image of the mixing console of the present invention.

### DESCRIPTION OF THE PREFERRED EMBODIMENT

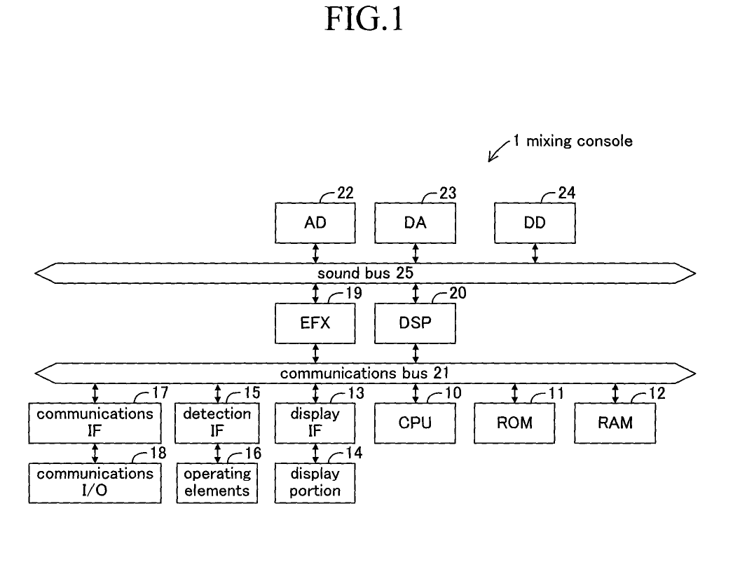

FIG. 1 is a block diagram indicative of a configuration of a mixing console according to an embodiment of the present invention. On a mixing console 1 indicated in FIG. 1, a CPU (central processing unit) 10 carries out a control program (OS: operating system) to control the entire mixing console 1 by the OS. The mixing console 1 has a nonvolatile ROM (read-only memory) 11 which stores operating software such as a mixing control program executed by the CPU 10, and a RAM (random-access memory) 12 which functions as working areas of the CPU 10 and stores various kinds of data. The CPU 10 carries out the mixing control program to allow a DSP (digital signal processor) 20 to process input sound signals to perform mixing processing. By employing a rewritable ROM such as a flash memory as the ROM 11, the operating software can be rewritten to facilitate updates of the operating software. Under the control of the CPU 10, the DSP 20 controls the respective tone volume levels and frequency responses of the input sound signals on the basis of set parameters, and mixes the sound signals to perform digital signal processing which controls sound characteristics such as tone volume, pan and effect on the basis of the parameters. An effector (EFX) 19 adds effects such as reverb, echo and chorus to the mixed audio signals under the control of the CPU 10.

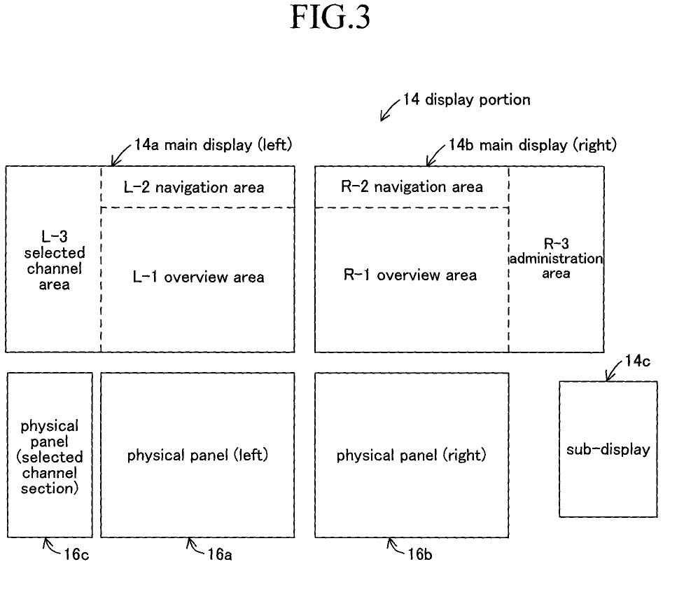

A display IF 13 is an interface for displaying a screen of various contents relating to mixing on a display portion 14. The display portion 14 is formed of main displays 14a, 14b each having a touch panel capability and a sub-display 14c having a touch panel capability as indicated in FIG. 3. A detection IF 15 scans operating elements 16 such as faders, knobs and switches provided on a panel of the mixing console 1 to detect user's manipulations of the operating elements 16 to edit or manipulate parameters used for sound signal processing on the basis of the detected manipulation signals. A communications IF 17, which is an interface for allowing the mixing console 1 to communicate with an external apparatus through a communications I/O 18, is a network interface such as Ethernet (trademark). The CPU 10, the ROM 11, the RAM 12, the display IF 13, the detection IF 15, the communications IF 17, the EFX 19 and the DSP 20 transmit and receive data and the like with each other through a communications bus 21.

The EFX 19 and the DSP 20 transmit/receive data and the like to/from an AD 22, a DA 23 and a DD 24 through a sound bus 25. The AD 22 is a plurality of analog input ports for inputting analog signals to the mixing console 1. The analog input signals input to the AD 22 are converted into digital signals before being transmitted to the sound bus 25. The DA 23 is a plurality of analog output ports for outputting mixed signals which have been mixed from the mixing console 1 to the outside. Digital output signals received by the DA 23 through the sound bus 25 are converted into analog signals before being output from speakers placed in a venue or on a stage. The DD 24 is a plurality of digital input/output ports for inputting digital signals to the mixing console 1 and outputting mixed digital signals to the outside. The digital input signals input by the DD 24 are transmitted to the sound bus 25, whereas the digital output signals received through the sound bus 25 are output to a digital recorder or the like. The digital signals transmitted from the AD 22 and the DD 24 to the sound bus 25 are received by the DSP 20 to be digitally processed as described above. The mixed digital signals transmitted from the DSP 20 to the sound bus 25 are received by the DA 23 or the DD 24.

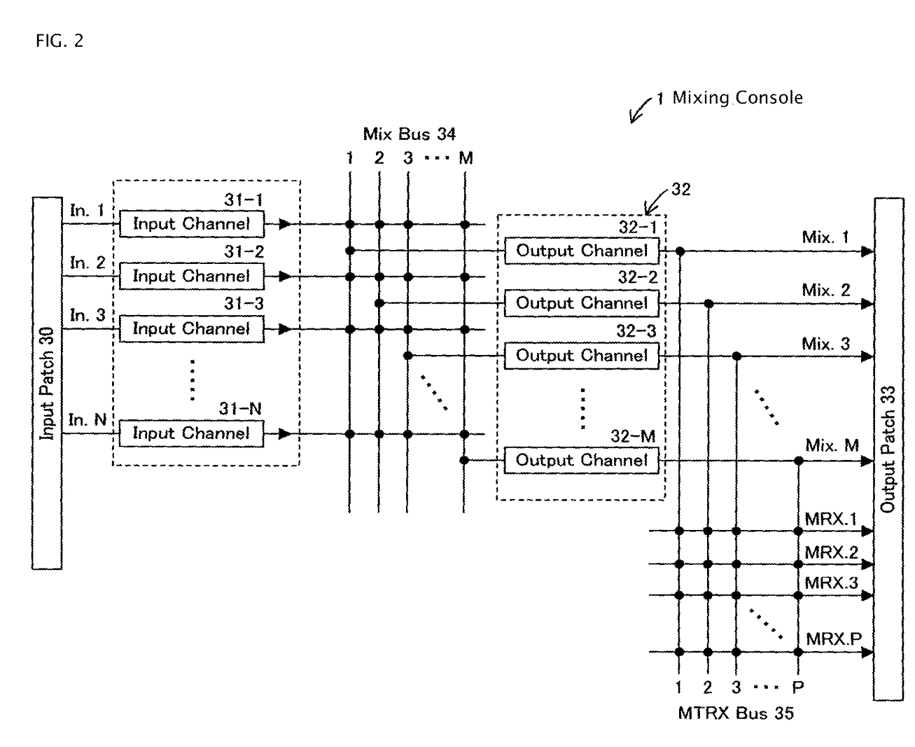

FIG. 2 is a block diagram indicative of an equivalent hardware configuration of a mixing algorithm executed on the mixing console 1. In FIG. 2, a plurality of analog signals input to the plurality of analog input ports (AD 22) are converted into digital signals before being input to an input patch 30. A plurality of digital signals input to the plurality of digital input port (DD 24) are directly input to the input patch 30. In the input patch 30, each of the input ports from which signals were input is selectively patched (connected) to one of input channels 31-1, 31-2, 31-3, . . . , 31-N included in an input channel portion 31 having N channels (N is an integer which is 1 or more: 96 channels, for example). To the respective input channels 31-1 to 31-N, audio signals In. 1, In. 2, In. 3, . . . , In. N transmitted from the respective input ports patched by the input patch 30 are supplied.

As for respective input channel signals supplied to the respective input channels 31-1 to 31-N of the input channel portion 31, characteristics of sound signals are controlled by an equalizer and compressor, with respective sending levels being controlled. The signals are then transmitted to a mixing bus (Mix Bus) 34 having M buses (M is an integer which is 1 or more: 24 buses, for example). In this case, the N input channel signals output by the input channel portion 31 are selectively output to one or more of the M buses of the mixing bus 34. In the respective buses of the mixing bus 34, one or more input channel signals selectively input from the input channel(s) included in the N input channels are mixed, resulting in a total of M different mixed outputs. The respective mixed outputs output from the respective buses of the M mixing bus 34 are output to respective output channels 32-1, 32-2, 32-3, . . . , 32-M included in an output channel portion 32 having M channels. In the respective output channels 32-1 to 32-M, characteristics of sound signals such as frequency balance are controlled by the equalizer and compressor before being output as output channel signals Mix. 1, Mix. 2, Mix. 3, . . . , Mix. M. The M output channel signals Mix. 1 to Mix. M are output to an output patch 33.

One or more of the M output channel signals Mix. 1 to Mix. M output from the output channel portion 32 are selectively transmitted to an MTRX bus 35 having P buses (P is an integer which is 1 or more: 8 buses, for example) which are matrix buses. In each of the P buses of the MTRX bus 35, one or more of the output channel signals selectively input from the output channel(s) included in the M output channels are mixed, resulting in a total of P different mixed outputs MRX. 1, MRX. 2, MRX. 3, . . . , MRX. P being output to an output patch 33. By the MTRX bus 35, as described above, sub-mixed signals MRX. 1 to MRX. P obtained by further mixing (sub-mixing), in the P different buses, the signals mixed by the mixing bus 34 are output. The sub-mixed signals can be used in the following case: In a case of a concert hall where music is played, with the first output channel being assigned vocal, the second output channel being assigned guitar, the third output channel being assigned drums, and the like, it is preferable that sound signals which are to be emitted from speakers placed in a lobby and hallways of the concert hall are the signals obtained by mixing the vocal, guitar, drums and the like. By mixing, by the MTRX bus 35, the output channel signals Mix. 1 to Mix. M representative of the vocal, guitar, drums and the like output by the output channel portion 32, therefore, the sub-mixed signals MRX. 1 to MRX. P output by the MTRX bus 35 can be emitted from the speakers placed in the lobby and the hallways.

The output patch 33 selectively patches (connects) each of the M output channel signals Mix. 1 to Mix. M output by the output channel portion 32 and the P sub-mixed signals MRX. 1 to MRX. P output by the MTRX bus 35 to one of the plurality of output ports (the DA 23 and DD 24). To the respective output ports, the output channel signals patched by the output patch 33 are supplied. In the output ports of the DA 23, digital output channel signals are converted to analog output signals to be amplified by an amplifier before being emitted from speakers placed in the venue. The analog output signals can be also supplied to in-ear monitors worn by musicians and the like performing on a stage, or reproduced by stage monitoring speakers placed near the musicians. Digital audio signals output by the digital output port portion (the DD 24) having a plurality of digital output ports can be supplied to a recorder or an externally connected DAT so that the digital audio signals can be digitally recorded.

FIG. 3 indicates a configuration of the display portion 14 of the mixing console 1 of the present invention and a configuration of the operating elements 16 provided on the panel. The display portion 14 is formed of main displays having the main display (left) 14a and the main display (right) 14b which are touch panels, and the sub-display 14c which is also a touch panel. Below the main display (left) 14a, a physical panel (left) 16a having the operating elements 16 forming channel strips of eight channels, for example, is provided. Below the main display (right) 14b, a physical panel (right) 16b having the operating elements 16 forming channel strips of eight channels, for example, is provided. On the left of the physical panel (left) 16a, a physical panel (selected channel section) 16c having the operating elements 16 is provided. The main displays offer intuitive manipulation on the touch panels to the user. On each main display, more specifically, respective areas for displaying screens for making various settings and a screen for manipulation are distinguished clearly. By displaying only necessary information only when the information is required, therefore, the mixing console 1 of the present invention enables intuitive manipulation, also preventing user's erroneous manipulation on the touch panels.

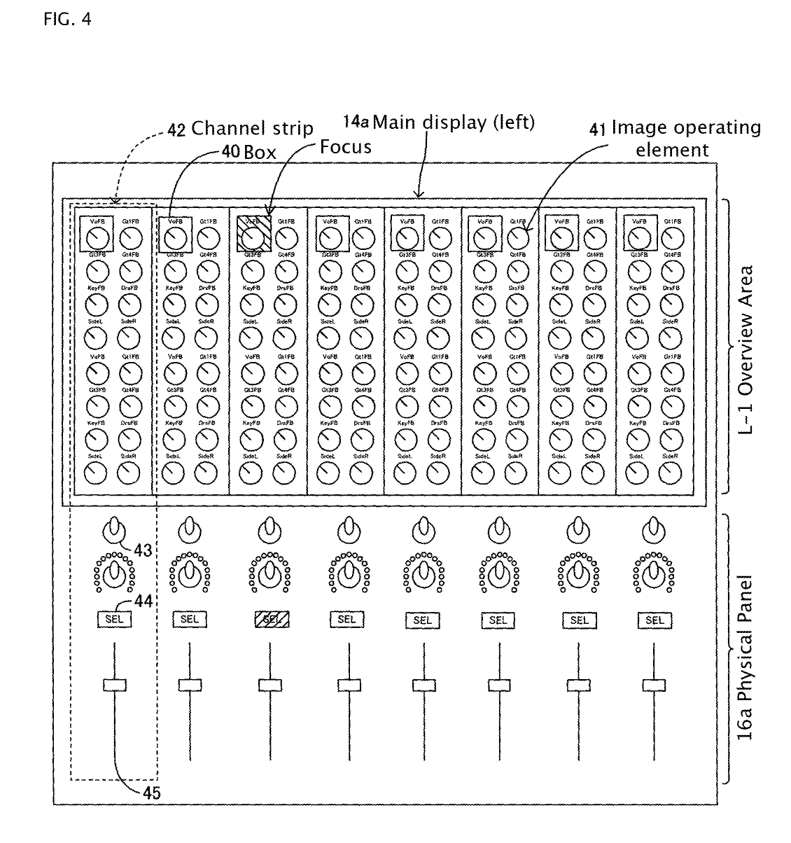

More specifically, the central area of the main display (left) 14a is an overview area L-1 where a screen for making various settings is displayed. On the overview area L-1, the channel strips of the eight channels provided on the physical panel (left) 16a are to be handled. The channel strips are designed such that image operating elements displayed on the main display (left) 14a are vertically linked seamlessly to the operating elements 16 provided on the physical panel (left) 16a, as displayed in a later-described example screen indicated in FIG. 4. An area situated above the overview area L-1 is a navigation area L-2 where a screen for setting various settings is displayed. On the navigation area L-2, the user selects a channel block which is to be assigned to the physical panel (left) 16a. Each channel block is formed of a certain number of channels such as eight channels. The navigation area L-2 displays all the channel blocks at all times so that the user can touch a user's desired channel block to assign the desired channel block to the overview area L-1 and the physical panel (left) 16a. Each channel block always displays input/output meters and fader positions in order to provide the user the outline of the channels of each block.

An area situated on the left of the overview area L-1 and the navigation area L-2 is a selected channel area L-3 where a screen for manipulation is displayed. The selected channel area L-3 displays image operating elements which allow the user at all times to manipulate important parameters of a currently selected channel. The selected channel area L-3 is designed to work with the physical panel (selected channel section) 16c, so that the user can manipulate, with the operating elements 16 provided on the physical panel 16c, all the items which require real-time operation of a channel assigned to the selected channel area L-3. The selected channel area L-3 displays those channel parameters which cannot be represented by the physical panel (selected channel section) 16c. Such channel parameters can be roughly grouped under “parameters for making a tone itself”, “parameters for routing” and “other parameters”. Without depending on respective states of the other areas in principle, the selected channel area L-3 always allows user's manipulations on the parameters of an assigned channel and displays the parameters of the assigned channel.

A central area of the main display (right) 14b is an overview area R-1 where a screen for making various settings is displayed. Because the overview area R-1 is designed similarly to the overview area L-1, the explanation about the overview area R-1 will be omitted. An area situated above the overview area R-1 is a navigation area R-2 where a screen for making various settings is displayed. Because the navigation area R-2 is designed similarly to the navigation area L-2, the explanation about the navigation area R-2 will be omitted. An area situated on the right of the overview area R-1 and the navigation area R-2 is an administration area R-3 where a screen for manipulation is displayed. The administration area R-3 serves as an area for the entire control to govern the entire modes of the mixing console 1, without depending on respective states of the other areas. Functions which cannot be represented by the parameters of the channels such as configuration on the mixing console 1 are to be invoked on the area.

FIG. 4 indicates an example screen displayed on the main display of the mixing console 1 of the present invention. In FIG. 4, an example screen of the overview area L-1 displayed on the main display (left) 14a and the configuration of the physical panel (left) 16a are indicated. The overview area R-1 of the main display (right) 14b displays a similar screen, with the physical panel (right) 16b being configured similarly.

The overview area L-1 of the main display (left) 14a indicated in FIG. 4 displays image operating elements 41 provided for respective parameters provided for each of the eight channels which configure the channel block assigned to the area. Each channel has the sixteen image operating elements 41 arranged in two lines to extend vertically. To the image operating elements 41 of each channel, parameters which are important to the channel and parameters which are to be handled in real time are assigned, respectively. Each channel's image operating elements 41 arranged in the vertical direction displayed on the overview area L-1 are linked seamlessly to the operating elements 16 which are arranged in the vertical direction and are provided on the physical panel (left) 16a, resulting in a channel strip 42 corresponding to the channel. FIG. 4 indicates a case where the channel strips 42 are provided for the eight channels. When the user touches one of the image operating elements 41 displayed on the overview area L-1, a parameter assigned to the touched image operating element 41 is to be selected. When the user touches the image operating element 41 assigned to the parameter “VoFB” of a channel, for example, the parameter “VoFB” is to be selected, so that boxes 40 enclosing the respective image operating elements 41 corresponding to the selected parameter are displayed. By touching one of the image operating elements 41, therefore, the parameter corresponding to the image operating element 41 is to be selected on each channel displayed on the overview area L-1, resulting in the boxes 40 enclosing the respective image operating elements 41 of the parameter “VoFB” provided for the respective channels being overlaid on the operating elements 41, respectively.

Once the parameter is selected as described above, the user is able to change the value of the selected parameter by manipulating an operating element 43 provided at the top of the physical panel (left) 16a. The parameter value which is to be changed is the selected parameter of a channel assigned to the channel strip 42 which has the manipulated operating element 43. The user is allowed to edit parameters by use of the operating elements 43 regardless of contents displayed on the sub-display 14c. If the user manipulates one of SEL keys 44 provided on the physical panel (left) 16a, the selected channel area L-3 and the physical panel (selected channel section) 16c are assigned the channel assigned to the channel strip 42 which has the manipulated SEL key 44. By manipulating the operating elements 16 provided on the physical panel (selected channel section) 16c, therefore, the user is able to edit the parameters of the assigned channel. By manipulating one of the channel faders 45 provided on the physical panel (left) 16a, the user is able to control the level of the channel assigned to the channel strip 42 which has the manipulated channel fader 45.

In the example of FIG. 4, the SEL key 44 of channel 3 which is the third channel from the left on the physical panel (left) 16a has been selected to illuminate. From among the selected parameters “VoFB”, therefore, the parameter “VoFB” of the channel 3 is selected to be focused. That is, the focused parameter “VoFB” is regarded as a target parameter which is to be controlled, with a sub-menu (context menu) formed of manipulation items relating to the target parameter, or an image for input (context pad) being displayed on the sub-display 14c at all times. Display modes of the sub-display 14c include a context menu mode and a context pad mode. In the context menu mode, the sub-display 14c displays a context menu formed of items of ancillary operating functions such as copy and paste of the focused parameter. The items included in the context menu vary according to the type of a focused parameter. In the context pad mode, the sub-display 14c displays, as a context pad, a software keyboard for inputting a numeric value to the focused parameter or a screen of surround pan in a case where the focused parameter is about pan. The number of parameters which can be specified by the focusing is one. That is, the sub-display 14c displays at all times, the context menu or the context pad for a focused parameter. The manner in which the sub-display 14c displays the screen will be described later.

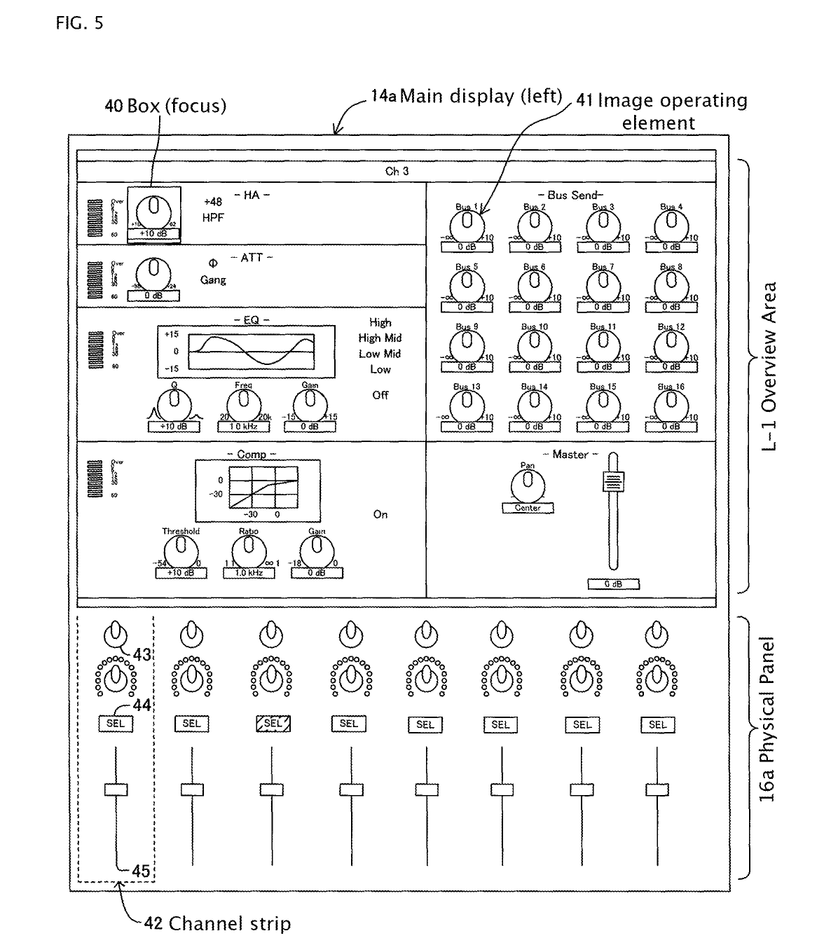

The overview area L-1 and the overview area R-1 can display a screen for detailed editing of a selected channel so that the user can make detailed settings on the selected channel on the screen. FIG. 5 indicates a state where the overview area L-1 displays the detailed editing screen. In the screen indicated in FIG. 5, the SEL key 44 of the channel 3 has been manipulated to illuminate, with the detailed editing screen for the selected channel 3 being displayed on the overview area L-1. As indicated in the figure, the channel 3 is an input channel, and the detailed editing screen displays the image operating elements 41 for controlling the level of head amp (HA), the attenuation level of attenuator (ATT), the curve of frequency response of equalizer (EQ), the curve of compressor (Comp), the send level to the mixing bus 34 and the master level. In the shown detailed editing screen, in addition, the image operating element 41 for controlling the head amp (HA) has been touched to display the box 40 enclosing the image operating element 41 of the head amp. In this case, the parameter on the level of head amp (HA) is focused, so that the sub-display 14c displays at all times, a context menu or a context pad for controlling the focused parameter. The mixing console 1 is designed such that when the user manipulates the SEL key 44 of the user's desired channel on the screen of the overview area L-1 indicated in FIG. 4, the screen of the overview area L-1 changes to the detailed editing screen indicative of the user's desired channel indicated in FIG. 5. However, the mixing console 1 may be modified such that the detailed editing screen pops up so that the detailed editing screen will be overlaid on the overview area L-1.

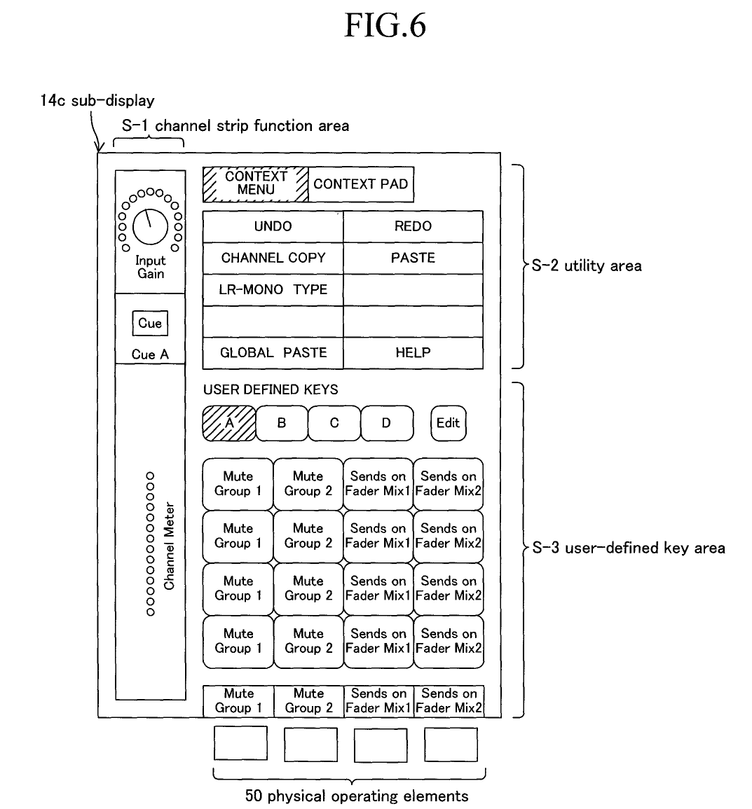

FIG. 6 indicates an example screen of the sub-display 14c. The sub-display 14c serves as an ancillary display portion provided in order to support user's manipulation of the main displays 14a, 14b to improve operability for the user. The sub-display 14c is a touch panel which offers intuitive operability. As indicated in FIG. 6, the sub-display 14c has three display areas: a left narrow channel strip function area S-1, an upper utility area S-2 and a user-defined key area S-3. The channel strip function area S-1 is assigned the operating elements corresponding to ASSIGNABLE FUNCTION ENCODER, Fn KEY, CUE KEY, and CHANNEL METER, respectively, included in the channel strip which has the focused parameter. More specifically, the channel strip function area S-1 displays functions which vary according to the focused parameter. In the case of FIG. 6, the channel strip function area S-1 displays a state where the ASSIGNABLE FUNCTION ENCODER is assigned Input Gain, with the CUE KEY and the CHANNEL METER also being displayed without displaying the Fn KEY (Function KEY). The utility area S-2 displays a context menu or a context pad for the parameter focused on the main display 14a, 14b. The context pad has an interface for inputting a value directly. In the case of FIG. 6, the utility area S-2 displays the context menu.

By user's touch of either the “context menu tab” or the “context pad tab” provided on the top of the utility area S-2, the utility area S-2 displays either the context menu or the context pad, depending on the tab that the user has touched. Alternatively, the precedence between the context menu and the context pad may be previously determined according to the type of a focused parameter, so that either the context menu or the context pad will be displayed on the utility area S-2. In the case of FIG. 6, the sub-display 14c is in the context menu mode, so that the context menu is displayed on the utility area S-2. In the user-defined key area S-3, user-defined keys of up to 24 keys are arranged on the screen. Above the user-defined keys, four switch keys for switching among banks A, B, C and D are provided. Therefore, user's definitions of up to 24×4 can be assigned to the keys. Next to the switch keys, an “Edit” key is provided. In the shown example, the key of bank A illuminates to indicate that bank A has been selected. Below the sub-display 14c, four physical operating elements 50 are arranged. Each physical operating element 50 is also able to be assigned a user-defined function. In the user-defined key area S-3, user-defined functions are assigned to GUI image operating elements and hardware operating elements, so that the user can use a function corresponding to a selected user-defined key. By user's touch of the “Edit” key, furthermore, a screen for programming user-defined keys appear to allow the user to program the respective user-defined keys.

The context menu displayed in the utility area S-2 of FIG. 6 is able to display buttons of the following items:

“COPY”: Save the target parameter to a copy buffer.

“CHANNEL COPY”: Save all the parameters of the channel strip having the target parameter to the copy buffer.

“PASTE”: Update the target parameter (or the channel including the parameter) with that stored in the copy buffer (paste the parameter stored in the copy buffer). There are different types of parameters such as level and frequency. Only in a case where the current target parameter is the same type of parameter as the copied parameter, therefore, the copied parameter can be pasted. In a case where the target parameter is not the same type of parameter as the copied parameter, the copied parameter cannot be pasted.

“COPY TO [ALL xxx↑↓](xxx: MIX/MATRIX)”: Update all the sends of the respective buses of the mixing bus 34 or the MTRX bus 35 of the channel with the target parameter of Send Level/On/Pan/Follow Fader. The copy buffer will not be used. In a case where the target is the mixing bus 34, “MIX” is to be assigned to “xxx”. In a case where the target is the MTRX bus 35, “MATRIX” is to be assigned to “xxx”. In general, the respective buses of a mixer are arranged in rows as in the case of the MTRX bus 35 of FIG. 2, so that the copy is conducted upward or downward. Therefore, the arrows “↑↓” are indicated in the item.

“COPY TO [ALL xxx] (xxx: CH/MIX/MATRIX/ST/DCA, etc.)”: Directly update all the channels with the target parameter. The copy buffer will not be used. “xxx” will vary according to the target. In a case where the target is a send parameter, “←→” is to be added, resulting in “COPY TO [ALL xxx ←→]”. In general, the respective buses of a mixer are arranged in rows as in the case of the MTRX bus 35 of FIG. 2, so that the copy is conducted in the lateral direction across the channels. Therefore, the arrows “←→” are indicated in the item.

“COPY TO [ALL xxx □ALL xxx]”: Update all the sends of all the channels with the target parameter of Send Level/On/Pan/Follow Fader. The copy buffer will not be used. “xxx” will vary according to the target, such as “COPY TO [ALL CH×ALL MIX]”.

“UNDO”: Put the current state back to the latest starting point of UNDO. The timing at which a starting point is created is immediately before the execution of the context menu for which UNDO is available or immediately after the opening of a pop-up (except some pop-ups). Up to ten starting points can be stored, with information on the oldest starting point being deleted at each storing of a new starting point. At the time of execution of the context menu for which UNDO is available, parameters which are to be retained at a starting point are all the parameters which are to be affected by the execution. At the time of opening of a pop-up, all the parameters which are to be handled by the pop-up are to be retained. By forcefully recalling a parameter group stored as a starting point (recall safe is not available), UNDO is achieved. The parameters which are to be affected by the execution of UNDO are to be stored immediately before the execution of UNDO as a starting point of REDO.

“REDO”: Put the current state back to the latest starting point of Redo. A starting point is created immediately before the execution of UNDO, so that all the parameters which are to be affected by the execution of UNDO are retained. Although the number of starting points is not limited, a starting point is created by an execution of UNDO. Actually, therefore, the number of starting points depends on the number of available UNDOs. The REDO becomes operative by an execution of UNDO. Once a modification is made to the parameter in the state where REDO is operative, however, all the starting points of REDO are to be deleted, so that the REDO becomes inoperative.

“SET DEFAULT”: Put a focused target parameter back to a default value.

“SET NOMINAL”: Set a focused target parameter at a nominal value (0 dB).

“SET DEFAULT (CHANNEL)”: Put the parameters of the channel strip having the target back to their respective default values.

“GLOBAL PASTE”: A GLOBAL PASTE screen is opened to paste (overwrite) only the focused target parameter to an existing Snapshot. The user is allowed to select a plurality of Snapshots to which the focused target parameter will be pasted. The Snapshot indicates sound settings provided by the DSP 20's signal processing by use of a parameter set for signal processing.

“GLOBAL PASTE (CHANNEL)”: The GLOBAL PASTE screen is opened to paste (overwrite) only the channel strip having the target to an existing Snapshot. The user is allowed to select a plurality of Snapshots to which the channel strip will be pasted.

“LR-MONO TYPE”: An LR-MONO TYPE SELECT screen is opened to prompt the user to select either stereo or monaural. The user is allowed to select the type only when the focused target is an input channel of STEREO TYPE.

“IDENTIFY”: The display portion 14 of a focused actual device blinks so that the user can identify the focused device even in a case where there are a plurality of devices. The blink will be canceled by a user's repeated selection of “IDENTIFY”.

“HELP”: A help screen is displayed to jump to the help of a selected element.

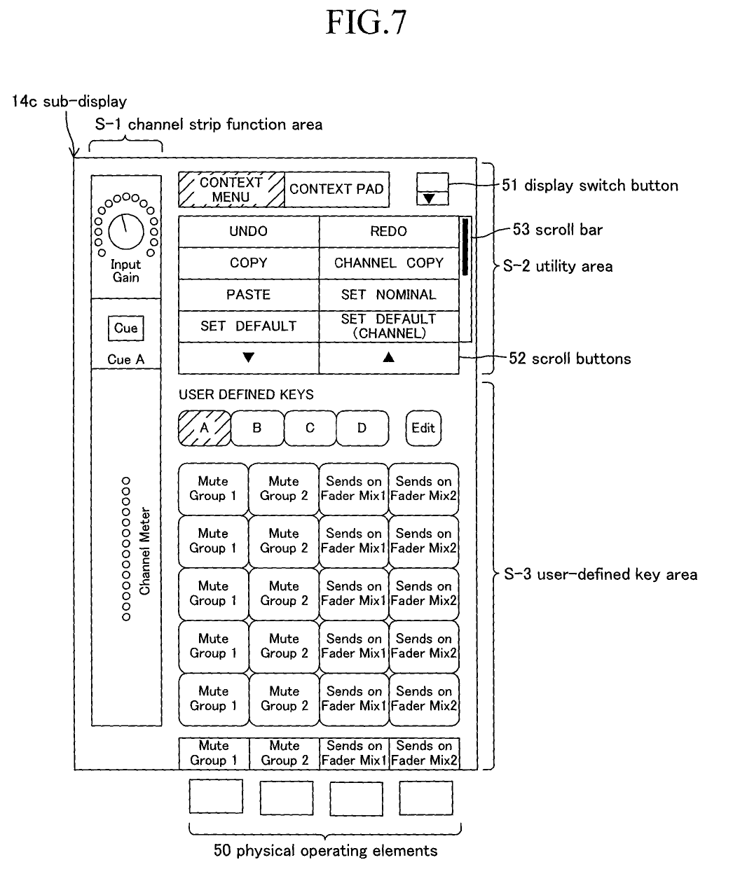

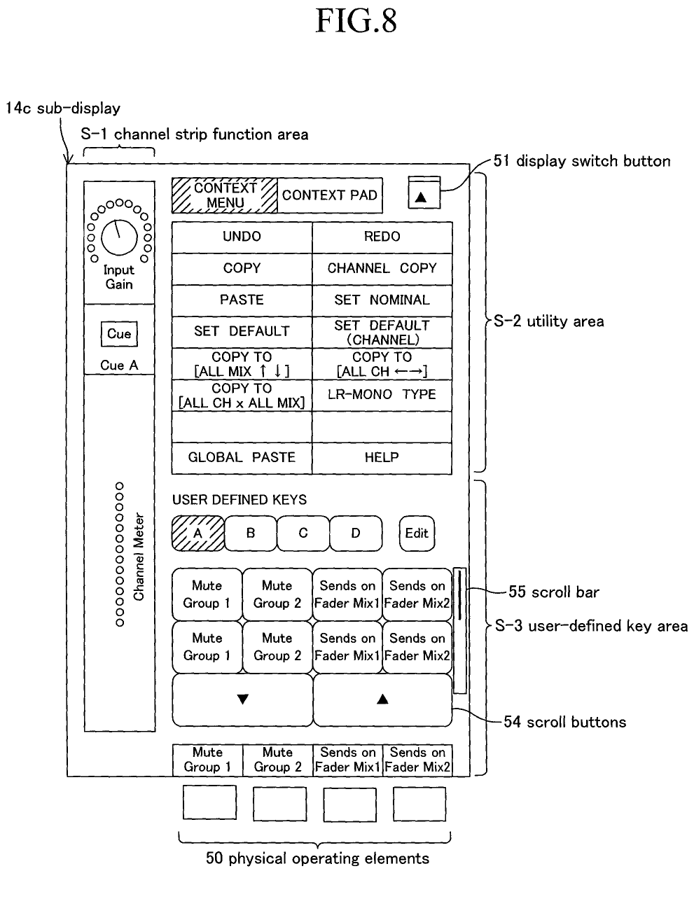

Because the context menu displayed on the utility area S-2 includes items which are related to a parameter, the contents of the context menu vary depending on the focused parameter. However, certain parameters share contents of the menu. Such parameters have so many items related to the focused parameter that the utility area S-2 of a limited width cannot display all the items in some cases. FIG. 7 and FIG. 8 indicate the other manners in which the utility area S-2 displays the context menu for such a parameter.

The display manners indicated in FIG. 7 and FIG. 8 are switchable by the manipulation of a display switch button 51 from the display manner of FIG. 7 to the display manner of FIG. 8, and vice versa. In the display manner of FIG. 7, without changing the arrangement of the user-defined keys displayed on the user-defined key area S-3, the context menu displayed on the utility area S-2 is allowed to scroll. In FIG. 7, therefore, the utility area S-2 displays scroll buttons 52 for scrolling up and down, with a scroll bar 53 indicative of the scroll provided along the right side of the context menu. By user's touch of either of the scroll buttons 52, the context menu is scrolled up or down so that items hidden in the context menu will appear on the utility area S-2.

In the display manner of FIG. 8, the utility area S-2 is enlarged so that more items included in the context menu can be displayed. However, the area of the user-defined key area S-3 is shrunk, so that the user-defined keys need to be scrolled up or down. On the user-defined key area S-3, therefore, scroll buttons 54 for scrolling up and down are provided, with a scroll bar 55 indicative of the scroll provided along the right side of the user-defined keys. By user's touch of either of the scroll buttons 54, the user-defined keys are scrolled up or down so that the hidden user-defined keys will appear on the user defined key area S-3.

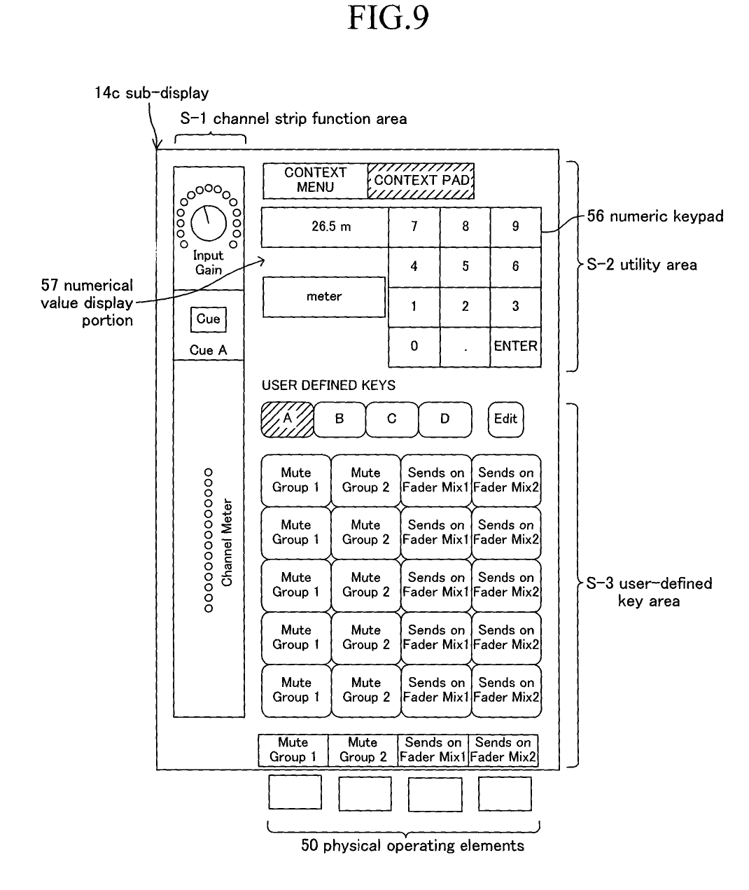

FIG. 9 indicates an example display manner of the context pad displayed on the sub-display 14c in the context pad mode. As indicated in FIG. 9, although the utility area S-2 displays the context pad in the context pad mode, the respective display manners of the channel strip function area S-1 and the user-defined key area S-3 will not change. In the display manner indicated in FIG. 9, the utility area S-2 displays a software numeric keypad 56 which serves as a context pad. On a numerical value display portion 57 provided on the left of the numeric keypad 56, a value of a focused parameter and the unit of the value are displayed. Immediately after the user has moved the focus, the current value is to be displayed on the numerical value display portion 57. FIG. 9 indicates a case in which a parameter of delay is focused, with 26.5 m being displayed on the numerical value display portion 57 to indicate a set distance from a main speaker to an operator room. By touching the numeric keypad 56, the user is allowed to specify a user's desired value so that the numerical value display portion 57 will display the specified value. By touching an “ENTER” key after specifying the value, the user confirms the specified value. The numerical value display portion 57 may be modified to serve as a cancel button as well so that the user can cancel the specified value by touching the numerical value display portion 57 after the user's specification of the value. In a case where a parameter of level is focused, the user is able to specify the user's desired level whose unit is dB by use of the numeric keypad 56. In a case where a parameter of frequency is focused, the user is able to specify the user's desired frequency whose unit is Hz or kHz by use of the numeric keypad 56.

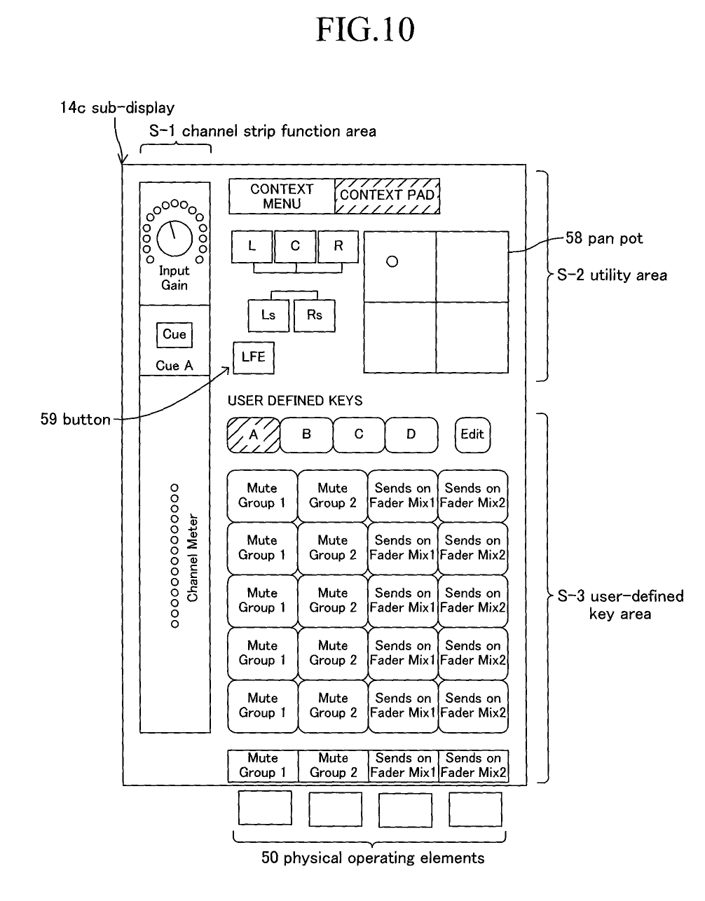

FIG. 10 indicates the other example display manner of the context pad displayed on the sub-display 14c in the context pad mode. The display manner of the context pad indicated in FIG. 10 is displayed in a case where a surround mini-graph is focused. In this case, more specifically, the utility area S-2 displays a two-dimensional pan pot 58 serving as a context pad. The pan pot is a mechanism for distributing a signal to a plurality of buses to localize sound image in accordance with differences in the level among the buses. On the left of the pan pot 58, a button 59 serving as a toggle for SEND ON to the respective surround buses is displayed. By touching the pan pot 58, the user is able to pan to the touched position. By dragging as well, the user can pan. In a case where the user drags to pan out of an operating range, clipping is performed to pan within the range.

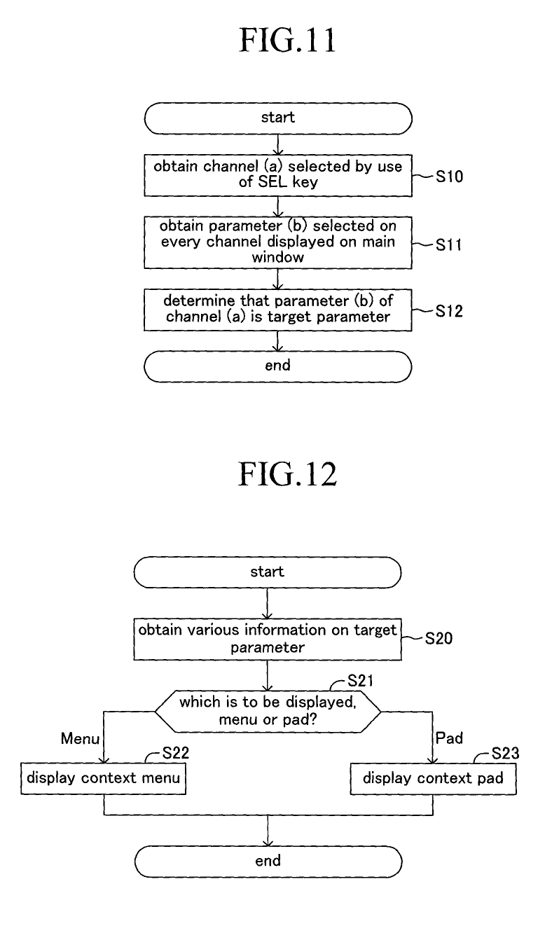

FIG. 11 is a flowchart of a target parameter determination process carried out on the mixing console 1 of the present invention. The target parameter determination process starts when a focused parameter changes to another parameter on the main display 14a, 14b, or when another channel has been selected by use of the SEL key 44. In step S10, a channel (a) selected by use of the SEL key 44 is obtained. In step S11, a parameter (b) selected on every channel displayed on the main display 14a, 14b is obtained. The parameter (b) selected on every channel is the parameter assigned to the image operating elements 41 enclosed with the boxes 40 in FIG. 4, for example. After the step S11, the process proceeds to step S12 to determine that the parameter (b) of the channel (a) is a focused target parameter. Then, the target parameter determination process terminates.

FIG. 12 is a flowchart of a context menu/pad drawing process executed on the mixing console 1 of the present invention. The context menu/pad drawing process starts when a target parameter has been determined by the above-described target parameter determination process, or when the user has touched either a “CONTEXT MENU tab” or a “CONTEXT PAD tab”. In step S20, various kinds of information on a focused target parameter is obtained. In step S21, it is determined which is to be displayed on the utility area S-2, the context menu or the context pad. In a case where the target parameter is defined as giving a higher priority to context menu, or in a case where the “context menu tab” has been touched, it is determined that the utility area S-2 is to display the context menu to proceed to step S22 where the context menu corresponding to the obtained target parameter is displayed on the utility area S-2. In a case where the target parameter is defined as giving a higher priority to context pad, or in a case where the “context pad tab” has been touched, it is determined in step S21 that the utility area S-2 is to display the context pad to proceed to step S23 where the context pad corresponding to the obtained target parameter is displayed on the utility area S-2. After the step S22 or step S23, the context menu/pad drawing process terminates.

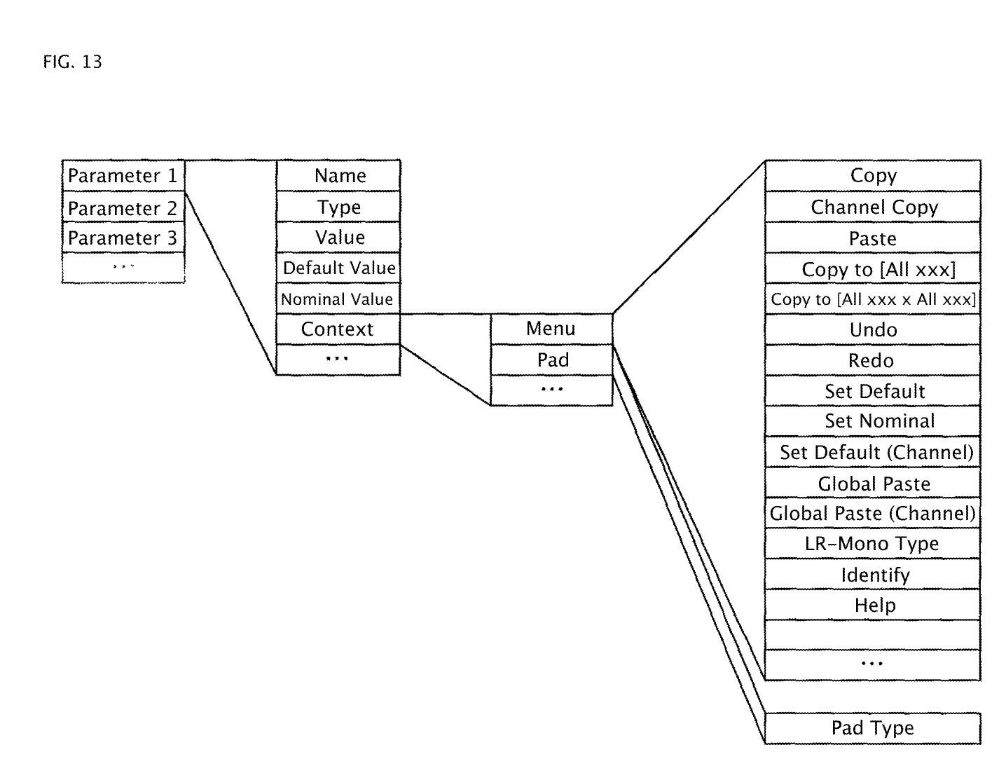

FIG. 13 indicates a memory image (data structure) of various kinds of parameters stored in the RAM 12 of the mixing console 1 of the present invention. As indicated in FIG. 13, Parameter 1, Parameter 2, Parameter 3, etc. which are the current parameters for signal processing on the mixing console 1 are stored in the RAM 12. As indicated by an example of Parameter 1, each parameter includes its “Name”, “Type”, “Value”, “Context”, “Nominal Value”, “Default Value”, etc. Among them, the information of “Context” includes information on “Menu”, “Pad”, etc. Furthermore, “Menu”, which is information on items, includes the above-described items of “Copy”, “Channel Copy”, “Paste”, “Copy to [All xxx]”, “Copy to [All xxx□All xxx]”, “Undo”, “Redo”, “Set Default”, “Set Nominal”, “Set Default (Channel)”, “Global Paste”, “Global Paste (Channel)”, “LR-Mono Type”, “Identify”, “Help”, etc. Among these items, the items corresponding to a focused parameter are to be displayed on the utility area S-2 by the step S22 of the context menu/pad drawing process. In addition, the information of “Pad” includes “Pad Type” indicative of a type representative of the numeric keypad 56 or the pan pot 58 so that the pad of either type corresponding to the focused parameter is to be displayed on the utility area S-2 by the step S23 of the context menu/pad drawing process.

On the mixing console described above, each main display which is a touch panel which is a first display portion is able to display a plurality of parameters provided for each of the channels. By user's touch of the image operating element displayed on the main display, the parameters corresponding to the touched image operating element are selected. By user's manipulation of the SEL key to select a channel, furthermore, the parameter which serves as a target parameter is determined. Once the target parameter is determined, the context pad which is a screen for inputting a value regarding the parameter is displayed on the sub-display which is a second display portion. When the user inputs a value on the context pad, the input value is reflected on the target parameter. In this case, independently of the display state of the sub-display, the parameters of the respective channels displayed on the main displays can be edited by use of the operating elements provided on the physical panel.

Although the present invention has been described as an invention of the mixing console, the present invention is not limited to the mixing console. That is, any sound apparatuses can be employed as long as they have two or more input channels, and mix sound signals input to the input channels to output the mixed signals. Furthermore, the mixing console of the present invention is designed such that the sixteen image operating elements 41 provided for each channel are arranged in two columns on the overview area. However, the arrangement of the image operating elements 41 is not limited to that of the present invention. That is, the number of operating elements 41 provided for each channel may be less than 16, or more than 16. Furthermore, the user-defined key area has 24 user-defined keys. However, the number of user-defined keys is not limited to 24. That is, the number of user-defined keys may be less than 24, or more than 24.

What is claimed is:

1. A mixing console comprising:
a first display portion which has a touch panel capability and displays sets of parameters, the sets relating to respective channels;
a selector which determines a parameter which is a target parameter to control, by detecting a touch of the first display portion to select the parameter corresponding to the touch from among the plurality of parameters displayed on the first display portion, and detecting a manipulation of an operating element for selecting a channel to select a channel corresponding to the manipulated operating element from among the channels;
a second display portion which has a touch panel capability and displays at all times a screen on which, in a case where the target parameter has been determined by the selector, a value relating to the parameter is input, and whose manner of inputting the value varies according to the type of the target parameter determined by the selector;
a first editor which allows editing of the parameters displayed on the first display portion, independently of what is displayed on the second display portion; and
a second editor which updates, in a case where the value relating to the target parameter has been input on the screen displayed on the second display portion, the parameter defined as the target parameter with the input value.

2. A mixing console according to claim 1, wherein
the screen which is displayed on the second display portion, and on which the value is input is a screen for inputting a numeric value.

3. A mixing console according to claim 1, wherein
the screen which is displayed on the second display portion, and on which the value is input is a two-dimensional screen for controlling pan position.
